(19) United States
(12) Patent Application Publication
(10) Pub. No.: US 2026/0065583 A1
(43) Pub. Date: Mar. 5, 2026

(54) METHODS AND APPARATUSES FOR IMMERSIVE VIDEOCONFERENCE

(71) Applicant: InterDigital CE Patent Holdings, SAS, Paris (FR)

(72) Inventors: Francois Le Clerc, L'HERMITAGE (FR); Philippe Henri Gosselin, Liffré (FR); Louis Chevallier, La Mézière (FR); Cedric Thebault, SAINT-AUBIN-D’AUBIGNE (FR); Abdallah Dib, Cesson Sevigne (FR)

(21) Appl. No.: 19/111,095

(22) PCT Filed: Sep. 7, 2023
(86) PCT No.: PCT/EP2023/074632

§ 371 Date: Mar. 12, 2025

(30) Foreign Application Priority Data
Sep. 12, 2022 (EP) 22306339.7

(51) Int. Cl. G06T 15/50; G06T 7/70; G06T 15/20; G06T 17/20

(52) U.S. Cl. CPC G06T 15/506; G06T 7/70; G06T 15/20; G06T 17/20; G06T 2207/10016; G06T 2207/30201

(57) ABSTRACT

Methods and apparatuses for encoding/decoding semantic description data representative of a 3D geometric and photometric face model for immersive telepresence are provided. In an embodiment, video data comprising a face of a user is encoded by extracting semantic description data representative of a 3D geometric and photometric model of the face of the user. In another embodiment, an immersive video is decoded from the semantic description data by, determining a head pose of the face of a remote user in an immersive video; determining a parametric model of a lighting environment of the immersive video; synthesizing the face of the remote user with the head pose and the parametric model; and generating a modified immersive video comprising an image of the synthesized face of the user in the immersive video. In an embodiment, the generation of the immersive video is made recurrent by taking at input the synthesized face and the immersive video at a previous frame.

### CROSS REFERENCE TO RELATED APPLICATIONS

This application claims the benefit of European Patent Application No. 22306339.7, filed on Sep. 12, 2022, which is incorporated herein by reference in its entirety.

### TECHNICAL FIELD

The present embodiments generally relate to a method and an apparatus for encoding/decoding semantic description data representative of a 3D face model for immersive telepresence. The present embodiments also generally relate to methods and apparatuses for encoding or decoding based on a neural network.

### BACKGROUND

Telepresence refers to the use of virtual reality technology, for instance for apparent participation in distant events. A popular application is found in a telepresence videoconferencing system that immerses the participants in a single common environment. Specifically, in a typical use case, such systems are meant to ensure that a user sitting at a table in a boardroom gets the impression that the other participants are sitting at the same table in the same boardroom, and directly looking at him or her when s/he talks.

An immersive telepresence system requires some computer vision processing on the captures of distant participants to achieve its goals. Typically, these captures are 2D videos obtained by commodity cameras. First, the head pose, i.e., the position and orientation of the head of the distant participant in the received images, needs to be changed at the receiver end to establish eye contact with the user in his/her viewing device. A similar operation should be performed on the location of the distant participant's iris to adjust the gaze direction. Second, the lighting of the face in the images of distant participants need to be replaced by the lighting of the virtual immersive environment that hosts the videoconference.

An efficient immersive telepresence system is therefore desirable that addresses two well-known problems for telepresence, (a) achieving proper pose and eye position of the rendered face to support proper eye contact, and (b) illuminating the rendered face with a lighting model appropriate to the immersive environment.

### SUMMARY

According to various embodiments methods and apparatuses for encoding/decoding semantic description data representative of a 3D geometric and photometric face model for immersive telepresence are provided.

According to an embodiment, a method is provided wherein the method comprises receiving semantic description data representative of a 3D model of a face of a user; determining a head pose of the face of the user in an immersive video; determining a parametric model of a lighting of an environment of the immersive video; synthesizing the face of the user with the head pose and under the parametric model of the lighting of the environment of the immersive video; and generating a modified immersive video comprising an image of the synthesized face of the user in the immersive video.

According to another embodiment, a method is provided wherein the method comprises receiving video data comprising a face of user; determining, by applying an encoder to the video data, semantic description data representative of a 3D model of the face of the user in the video data; and providing semantic description data for rendering the face of the user in an immersive video.

One or more embodiments also provide an apparatus comprising one or more processors configured for performing any one of the embodiments of the methods cited above.

One or more embodiments also provide a computer program comprising instructions which when executed by one or more processors cause the one or more processors to perform any one of the methods according to any of the embodiments described above. One or more of the present embodiments also provide a computer readable storage medium having stored thereon instructions for editing a video shot, encoding at least one image or a video or decoding at least one image or a video according to the any of the embodiments described above.

One or more embodiments also provide a bitstream comprising image or video data encoded according to any one of the embodiments of the encoding method cited above. One or more of the present embodiments also provide a computer readable storage medium having stored thereon a bitstream described above.

One or more embodiments also provide a method for transmitting a bitstream comprising image or video data encoded according to any one of the embodiments of the encoding method described herein. One or more embodiments also provide an apparatus for transmitting a bitstream comprising image or video data encoded according to any one of the embodiments of the encoding method described herein.

### BRIEF DESCRIPTION OF THE DRAWINGS

FIG. 1 illustrates a block diagram of a system within which aspects of the present embodiments may be implemented, according to an embodiment.

FIG. 2 illustrates a block diagram of a system within which aspects of the present embodiments may be implemented, according to another embodiment.

FIG. 3 illustrates schematically a telepresence system within which aspects of the present embodiments may be implemented, according to an embodiment.

FIG. 4 illustrates schematically a method for processing the 2D face images of facial reenactment according to an embodiment.

FIG. 5 illustrates schematically a telepresence system with its encoder and its decoder, implementing the method according to the present invention.

FIG. 6 illustrates schematically the components of the 3D environment model according to an embodiment.

FIG. 7 illustrates a method for training an NN auto-encoder generating semantic data according to another embodiment.

FIG. 8 illustrates a method for training a Generative Adversarial Network (GAN) generating photo-realistic immersive video according to another embodiment.

FIG. 9 illustrates a method for generating a photo-realistic immersive video refined using Generative Adversarial Network (GAN) according to another embodiment.

FIG. 10 illustrates a method for decoding at least one image according to another embodiment,

FIG. 11 illustrates a method for encoding at least one image according to another embodiment.

FIG. 12 illustrates a method for decoding at least one image according to another embodiment.

FIG. 13 shows two remote devices communicating over a communication network in accordance with an example of present principles.

FIG. 14 shows the syntax of a signal in accordance with an example of present principles.

### DETAILED DESCRIPTION

The present principles will be now described in the particular case of an immersive videoconference. However, the present principles are not limited to videoconferencing, but could be directly and non-ambiguously derived to any telepresence system where the representation of the user is driven by a distant capture of his or her face by a camera. Such systems include, but are not limited to, gaming frameworks where the user is represented by an avatar whose motion and expressions are driven by the distant live video capture, or more generally frameworks falling in the scope of the Metaverse where participants interact in a virtual environment through their embodiments as avatars and the avatar appearance, motion and expression is driven by a distant live video capture of the participants' faces. Such frameworks can host commercial applications such as e-learning, e-tourism and e-commerce, to name a few.

FIG. 3 illustrates schematically a telepresence system within which aspects of the present embodiments may be implemented, according to an embodiment. The telepresence system of FIG. 3 comprises three communication apparatus D1, D2, D3 connected through a communication network. The communication apparatus D1 comprises a camera for capturing a scene as a succession of images forming video data. The captured scene is constituted here at least by the face of a first user P1 for instance in front of a table T. The communication apparatus D1 further comprises a display for rendering a video in which the remote users P2 and P3 are displayed in an immersive environment, for instance in front of a representation of a same table T and apparently directly looking at the user P1. As represented on the right part of FIG. 3, the user P1 is also represented in the immersive environment by the display of the communication apparatus D2 or D3, for instance in front of a representation of the same table T and also apparently looking at the user P2 or P3.

To achieve the rendering of a common immersive environment in the telepresence system, the communication apparatus D1 comprises a transmitter/encoder used to process the captured video data as described below and to provide description data for synthesizing the face of the user P1 in the remote communication device D2 or D3. The communication apparatus D1 also comprises a receiver/decoder for receiving and processing description data provided by the remote communication devices D2, D3 and rendering the face of the users P2 and P3 in the immersive video displayed by the communication device D1.

Similarly, the communication apparatus D2 is capable of reproducing a video with immersive effect thanks to which user P2 viewing immersive video reproduced on apparatus D2 will get the impression that the user P1 is sitting at the same table T, and directly looking at him or her when s/he talks. This is made possible thanks to receiver/decoder of the apparatus D2 which implements the method of the present principles according to the at least one embodiment by processing the following processing steps:
receiving semantic description data representative of the geometric and photometric components of the 3D model of a face of a first user P1;
determining a head pose of the face of the first user P1 in an immersive video;
determining a parametric model of the lighting of the environment of the immersive video;
synthesizing the face of the first user P1 with the head pose and the lighting model; and
generating a modified immersive video comprising an image of the synthesized face of the first user P1 in the immersive video.

In a refined embodiment of the decoding steps, the generating further takes as input the synthesized face of the first user and the modified immersive video at a previous frame to enhance the displayed immersive video.

Thus, according to the at least one embodiment, instead of transmitting/encoding 2D video data representing the face of a first user, the transmitter/encoder of the apparatus D1 processes the 2D video data to obtain, by applying an encoder to the video data, semantic description data representative of a 3D model, for instance a 3D geometric and photometric model, of the face of the first user in the first video data; and provides the semantic description data for rendering the face of the first user in an immersive video. Advantageously, the at least one embodiment allows to significantly reduce the amount of data to transmit on the communication network. Beside low bitrate, the skilled in the art will appreciate that the semantic data are independent of the resolution of the displayed video data, therefore the compression efficiency is all the more important that the resolution of the displayed video is high.

In order to obtain the semantic description data, it is proposed to adapt some processing for instance used in a face reenactment scheme. By using semantic description data of the user face, the present principles in particular addresses two well-known problems for telepresence, (a) achieving proper pose and eye position of the rendered face to support proper eye contact, and (b) illuminating the rendered face with a lighting model appropriate to the immersive environment. The disclosed adaptation proposes an instantiation of the face reenactment scheme in at least two remote devices. However, the present principles are not limited to the particular face reenactment embodiment described hereafter, and any method that would provide semantic description data allowing the reconstruction of the face of a user in an immersive environment is compatible with the present principles. Advantageously, such methods could be either embarked on a user smartphone, a user laptop or deployed on the cloud of social networks.

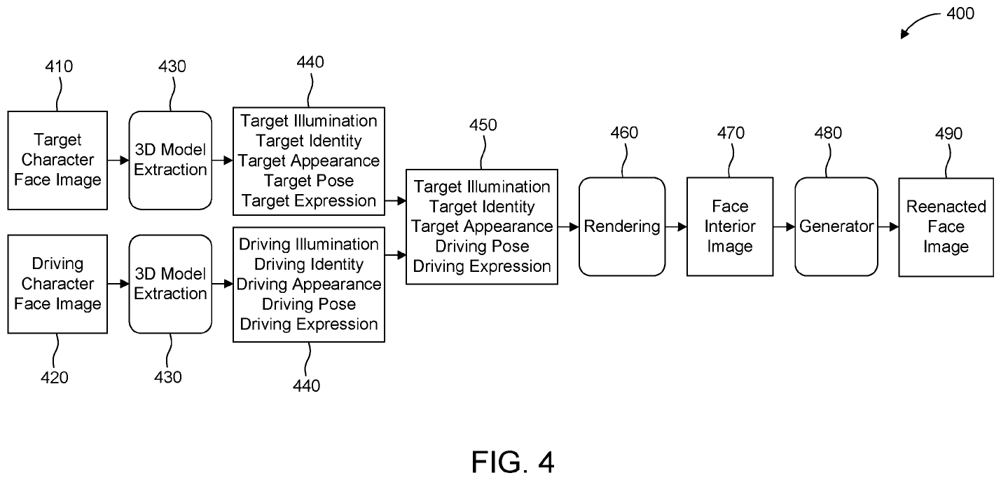

FIG. 4 illustrates schematically a method for processing the 2D face images of facial reenactment according to an embodiment. The goal of facial reenactment is to transfer a driving character's expression and head pose to a target face while preserving the target identity. To that end, semantic data related the face of the target character and to the face of the driving character are determined. An example of a facial reenactment scheme is disclosed in the paper “Deep Video Portraits” from H. Kim et al, published in the ACM Transactions on Graphics (volume 37 no 4, pp. 163:1-163:14, 2018). As shown in FIG. 4, the reenactment pipeline 400 is fed with two face images, one for the target character 410 whose face is to be rendered and one for the driving character 420, who determines facial pose and expression in the output image. In the Deep Video Portraits paper, to improve the temporal consistency of the output, the inputs are two temporal chunks of face images instead of two images, but this does not change the principle of the approach that is described below. A front-end module 430 extracts a semantic parametric 3D face model 440 from each of these images 410, 420. The model addresses only the interior part of the face, including the eyes, nose and mouth but not the hair. The semantic parametric 3D face model consists of the following components:
identity: a 3D mesh representing the 3D geometry of the face with a neutral expression, i.e., the facial physiognomy of the character;
expression: the displacements of the vertices of the neutral expression mesh incurred by facial expression, typically as a result of showing an emotion and/or uttering speech;
pose (or head pose, or rigid head pose): the 3D rotation and translation of the face in the image, with respect to the fronto-parallel viewpoint;
appearance: the skin reflectance on the surface of the 3D geometry mesh; and
illuminant: a parametric model of the lighting environment of the face.

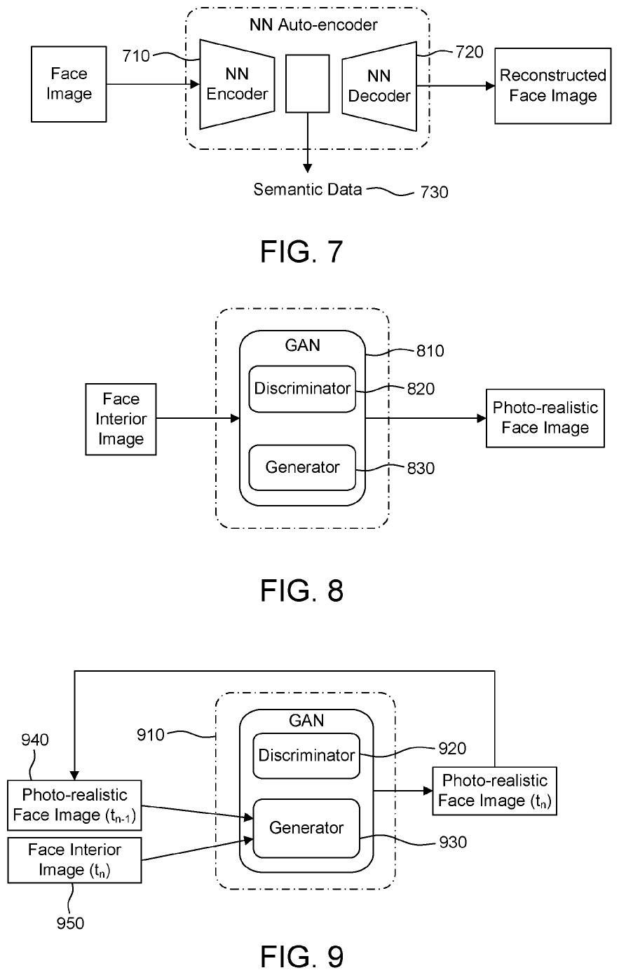

The 3D model extraction 430 can be performed in several ways. In the above-cited Deep Video Portraits paper, it is obtained by an analysis-by-synthesis method that minimizes, through an optimization scheme with respect to the model parameters, the discrepancy between the face interior region of the actual image and the reconstruction of the face interior region from the computed model parameters. However, the present principles are not limited to the optimization-based computation of the semantic face parameters from the image as proposed by Kim et al. For instance, an NN autoencoder as proposed below regarding FIG. 7 wherein the decoder module of the NN autoencoder provides the face synthesizing module in the remote device, can be used to generate the semantic description data according to a variant embodiment.

The purpose of the reenactment scheme is to generate an output face image that has the identity and environment of the input target character, but the pose and expression of the driving face. Thus, the target character can be viewed as a puppet whose expression and head pose are controlled by the driving character face. To this end, as shown on FIG. 4, first 3D face model parameters 440 are extracted both for the target face and the driving face. Then, a mixed face model 450 consisting of the identity, appearance and illuminant components of the target face, and the pose and expression of the driving face, is assembled. Finally, a rendering module 460 synthesizes a face image from this mixed model 450. The rendering operation amounts to reconstructing the face interior image 470 using the image formation process implied by the semantic model parameters 450. The module 460 outputs a synthetic face interior image 470 determined from the set of model parameter values. Finally, the generator module 480 converts the synthetic face interior image 470 into full frames of a photo-realistic image 490, in which the target character now mimics the head motion, facial expression and eye gaze of the driving character. The generator module 480 is user-specific. It is a neural network trained on a video of the target character with a given background, a given haircut and given clothes. The photo-realistic image 490 it outputs combines the background, haircut and clothing represented in the training video with a rendering of the target character face driven by the mixed face model inputs 450. It is trained to render the target character face in each image at the same position and with the same orientation and scale as the face interior image 470 at its input.

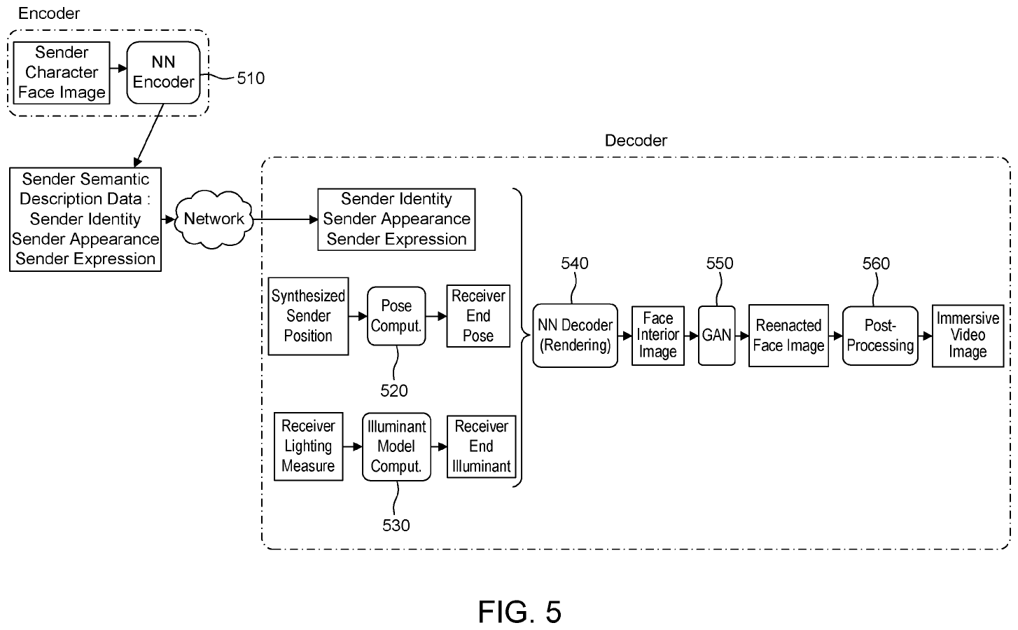

FIG. 5 illustrates schematically a telepresence system with its encoder and its decoder, implementing the method according to the present invention. For clarity, but without loss of generality, the telepresence scheme will focus on a scenario with just two participants, a sender and a receiver. FIG. 5 shows a novel arrangement of the modules of the reenactment scheme of FIG. 4 where the modules are implemented in remote devices of a telepresence system, namely the communication device of the sender and the communication device of the receiver.

In the arrangement of FIG. 5, the encoder, also referred to as transmitter, comprises an encoding module 510 which performs a task corresponding to the 3D model extraction module. From the captured 2D video of the sender's face, it extracts semantic description data representative of a parametric 3D face model of the sender's face. The model addresses only the interior part of the face, including the eyes, nose and mouth but not the hair. The sender semantic description data at least comprises:
an indication of an identity representative of a physiognomy of the sender with a neutral expression, for instance a 3D mesh representing the 3D geometry of the sender's face with a neutral expression;
an indication of an expression representative of an emotional expression with respect to the neutral expression of the sender, typically as a result of showing an emotion and/or uttering speech; for instance a plurality of displacements of vertices of the 3D mesh incurred by the facial expression; and
an indication of an appearance representative of a reflectance of the user, for instance a skin reflectance on the surface of the 3D mesh.

The sender semantic description data is then packaged in a bitstream and provided through the communication network to a remote receiver's device for immersive rendering. The communication device of the receiver receives the sender semantic description data representative of a parametric 3D face model of the sender's face and computes the expected head pose of the sender's face in the immersive environment as well as a parametric model of a lighting environment of the sender's face in the immersive environment.

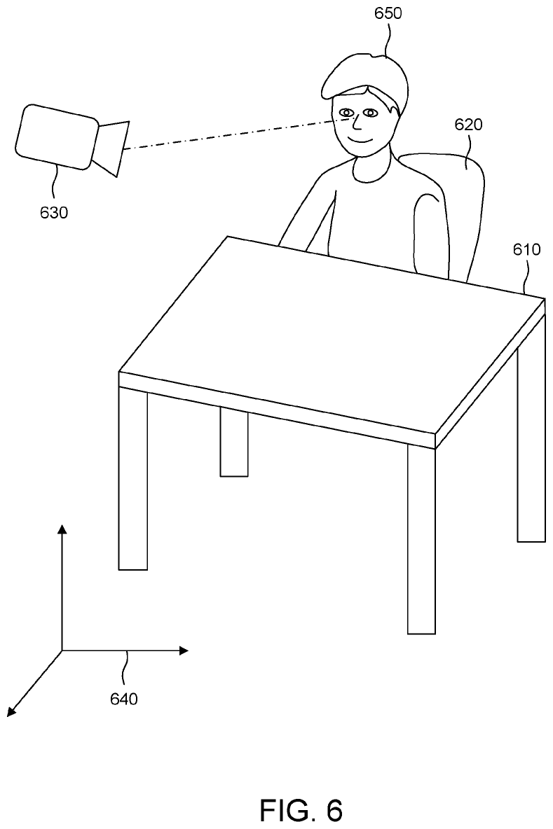

FIG. 6 illustrates schematically examples of the components of a 3D environment model according to an embodiment. The immersive environment in which participants in the videoconference are represented is obtained from a predetermined 3D model of a scene. For example, this scene could represent a room with a floor, walls and windows, further comprising a table 610 and chairs 620 around this table 610. In this example, in case of multiple participants in the videoconference system, each user would be assigned a predetermined chair 620 on which s/he would be represented sitting in the immersive video displayed on the receiver devices of the other participants. At each receiver device, the image of the virtual environment is computed by rendering the projection of the aforementioned 3D environment model on the image plane of a virtual camera 630 whose position, attitude and optical parameters, comprising in particular its focal length, are predetermined.

Back to FIG. 5, at each receiving device, the pose estimation module 520 computes the head pose of the 3D model of the sender's face that drives the computation of the sender's face image, so that this image can be directly overlaid on the rendering of the environment. In the aforementioned example scene of FIG. 6, the head pose 650 is computed so that the image resulting from the overlay represents the sender sitting on the predetermined seat that was assigned to him or her, with his or her face looking at the virtual camera. The 3D head pose model consists of scale, translation and rotation components, defined in the 3D coordinate system 640 of the predetermined 3D scene model as shown on FIG. 6. The computations performed by the pose estimation module 520 amount to positioning, aligning and scaling the sender 3D face model inside the virtual environment. In more detail, these computations involve:
first, adjusting the scale component to match the physical dimensions of the scene, for instance, adjusting the width of the sender 3D face model so that it is consistent with the dimension of chairs in the 3D scene model;
second, setting the translation vector to the displacement vector from the optical center of the virtual camera to the expected position of the center of the sender's face in the 3D scene;
third, adjusting the rotation angles of the head pose so that the sender's gaze is directed towards the optical center of the virtual camera.

These processing steps achieve eye contact between the receiver and the representation of the sender on the receiver's display. The illuminant computation module 530 provides the receiver's device at every frame of the video with a model of the lighting of the virtual immersive environment. This model is typically computed by a 3D authoring tool as a function of light sources positioned by the artist who designed the 3D scene, for instance as a set of spherical harmonic coefficients on a sphere mapping of the 3D scene. Then a mixed 3D model is generated with the received identity, expression and appearance components of the sender's face, and the computed head pose and illuminant components of sender's face in the immersive environment. The rendering module 540 synthesizes the face interior image of the sender in the immersive environment from this mixed 3D model. Next, the generator module 550 converts the synthetic face interior image into full frames of a photo-realistic video of the sender. As will be discussed further below, according to an embodiment, the rendering module 540 and/or the generator at 550 are based on a neural network trained on a video of the sender's face against a uniform background. The frames output by the generator 550 replicate this background. As a final post-processing step 560, the foreground region representing the sender is extracted in each frame output by the generator 550 using color keying techniques known from the state of art, and overlaid on the rendering of the 3D environment. This rendering is obtained by projecting the aforementioned 3D environment model to the image plane of the aforementioned virtual camera. Owing to the adjustments of the head pose performed by the pose computation module 530, the head pose used to compute the face interior image fed to the GAN matches the expected position, orientation and scale of the 3D model of the sender's head in the environment. As a result, the image of the sender's head at the output of the generator 550, which is rendered at the same position and with the same orientation and scale as the face interior image at the generator input, can be overlaid directly on the aforementioned rendering of the environment to produce an image where the sender's face and orientation is consistent with the rest of the scene.

According to a variant embodiment wherein the immersive environment is pre-defined and might be used in the training of the NN based rendering module 540 and/or the generator at 550, the generator module 550 directly converts the synthetic face interior image into full frames of a photo-realistic video of the sender into the pre-defined immersive environment. The skilled in the art will appreciate that in that case, a single sender is rendered into the immersive video. Advantageously, in the variant, the extraction of the foreground sender's head from the background and the final compositing step are avoided.

Variant embodiments of an encoding module 510 and decoding module 540 of semantic description data representative of a geometric and photometric 3D face model are now described. According to a first variant, the encoding module 510 implements the 3D model extraction of the Deep Video Portraits paper. Accordingly, this module performs an analysis-by-synthesis optimization of the model parameters, whose objective is to minimize the discrepancy between the face interior region of the 2D captured image and the reconstruction of the face interior region computed from the model parameters. The semantic parametric 3D face model comprising the parameters representative of identity, expression, (rigid) head pose, appearance and illuminant of the sender are computed to achieve this target. The analysis-by-synthesis method for reconstructing the face interior region of the sender from the hypothesized 3D face model parameters is integrated in the encoder.

According to a second variant, the encoding module 510 is a neural network encoder part of a neural-network NN auto-encoder trained on a dataset of face images.

FIG. 7 illustrates a method for training an NN auto-encoder generating semantic data according to another embodiment. Such a method was originally proposed in the paper by A. Tewari et al, “MoFA: Model-Based Deep Convolutional Face Autoencoder for Unsupervised Monocular Reconstruction”, published in the 2017 International Conference on Computer Vision. This network consists of an encoder module 710 followed by a decoder module 720. The encoder outputs the sought 3D semantic parametric model 730 of the input face. The decoder is hand-crafted to reconstruct an image of the face interior from the model parameters. The network is trained end-to-end to minimize a reconstruction loss on the face interior image. Here the training dataset consists of a large collection of face images with various physiognomies, head poses, expressions and lighting conditions. Once the autoencoder has been trained, the NN encoder part is used as encoding module 510 as shown on FIG. 5 while the NN decoder part of the auto encoder is used as decoding module 540. Therefore, before starting an immersive videoconference, the decoding device (decoder) configures the decoding module 540 with the trained NN decoder.

Variant embodiments of the generator module 550 are described in the following sections.

According to a first variant, the generator module 550 implements a Generative Adversarial Network (GAN) described in the Deep Video Portraits paper. FIG. 8 illustrates a method for training a Generative Adversarial Network (GAN) generating photo-realistic immersive video according to another embodiment. The purpose of the generator module 550 at the back end of the videoconference system of FIG. 5 is to remove the artefacts in the face interior region to make it look like a plausible face, as well as to form a full image by hallucinating the hair region, the background, as well as parts of the face that are not visible in the synthesized face interior image at the generator input. These parts include the interior of the mouth, that may become visible as a result of the driving facial expression. On FIG. 8, the GAN is represented by module 810. It consists of a discriminator module 820 and a generator module 830 corresponding to module 550 of FIG. 5. The GAN is typically designed as a conditional Generative Adversarial Network where the generator network 830 and the discriminator network 820 are trained jointly, and conditioned on some input that drives the generation process, as originally proposed in the arXiv:1411.1784 paper “Conditional Generative Adversarial Nets” by M. Mirza and S. Osindero, available at https://arxiv.org/pdf/1411.1784.pdf. A GAN is a generative model that synthesizes new images that are consistent with the content of the dataset it is trained on. Here the training dataset consists of face images of the sender under a given uniform background. Further, a conditional GAN is trained to produce images that are consistent with the conditioning data provided at its input. Hence, after convergence the conditional GAN generator should produce a plausible face image of the sender in the same background, and with the same physiognomy and expression as the synthetic face interior image provided as conditioning input.

Since it is conditioned by its interior face image with the desired pose and expression of the driving face, the reenacted face image at its output should also have the desired pose and expression. However, the task of the generator module is a difficult task, as it is expected to both hallucinate the missing output image parts but also to make the synthetic face interior image, built from a simplistic face model, photorealistic.

According to a second variant, the generator module 550 is refined to improve the plausibility of the images it produces by feeding it with an additional input that is closer to the output it needs to produce. FIG. 9 illustrates a method for generating photo-realistic immersive video refined using Generative Adversarial Network 910 (GAN) according to another embodiment. Advantageously, the generator 930 is fed with data that is closer to the image it has to synthesize at its output, thereby reducing the difficulty of the task it has to perform and improving its performance. Indeed, a temporal feedback loop is introduced in the generator, as shown on FIG. 9. The photo-realistic face image 940 that is the generator output at frame n-1, corresponding to time tₙ₋₁ of the processed video, is stacked with the face interior image 950 computed by the rendering module at time tₙ to form the input to the generator 930 at time tₙ. The differences between the photo-realistic images in two consecutive time steps is expected to be small, as the changes in pose, lighting and, to a lesser extent, expression in the faces of the participants to a videoconference are expected to be small for typical values of the video sampling period. Thus, the photo-realistic face image at tₙ₋₁ provides the generator with a strong cue on what output it should generate at tₙ.

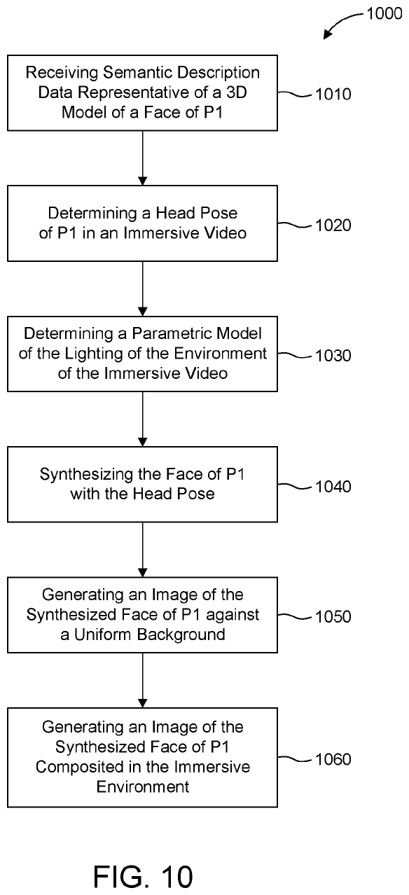

FIG. 10 illustrates a method 1000 for decoding semantic description data representative of a face of a user and generating an immersive video including the face of the user according to an embodiment. In a first step 1010, semantic description data representative of the 3D geometric and photometric model of a face of a remote user is received. For instance, the semantic description data form part of a bitstream. In a step 1020, a rigid head pose of the face of the remote user in an immersive video is computed as described above with reference to FIG. 5 and FIG. 6. In a step 1030, a parametric model of the lighting of the virtual environment of the immersive video is obtained. The rigid head pose, the lighting of the virtual environment along with the received parameters allows to synthesize in a step 1040 a rendering of the face of the user to be composited in the immersive video. Then, in a step 1050, a photorealistic image of the face rendering is generated against a uniform background. Finally in a step 1060, the region of the photorealistic face representing the user is segmented out from the uniform background and overlaid on a predetermined image rendering of the virtual environment to generate a frame of the modified immersive video. As above-mentioned, according to a variant, the steps 1050 and 1060 are jointly performed in a generating step in the case where the immersive environment is set to correspond to the background captured in the training video of the sender's face. According to a variant, the generation in step 1050 is performed using a GAN. Although, the present principles are not limited to a GAN for the generating step, the skilled in the art will appreciate that the GAN is currently the most efficient implementation to generate such photorealistic images from synthetic views. Advantageously, the method 1000 consequently reduces the amount of data to transmit in a videoconference system by decoding the semantic description data of a 3D face model instead a 2D video data. Besides, the method advantageously achieves proper pose and eye position of the rendered face to support proper eye contact and illuminates the rendered face with a lighting model appropriate to the immersive environment. According to another variant, the generation is made recurrent by taking at input the synthesized face of the user and the immersive video at a previous frame as described for FIG. 9. Advantageously, the generator output at the previous frames provides strong cues as to what should be generated at the current frame. Making these data available at the generator input helps it produce a better-quality video with fewer artifacts.

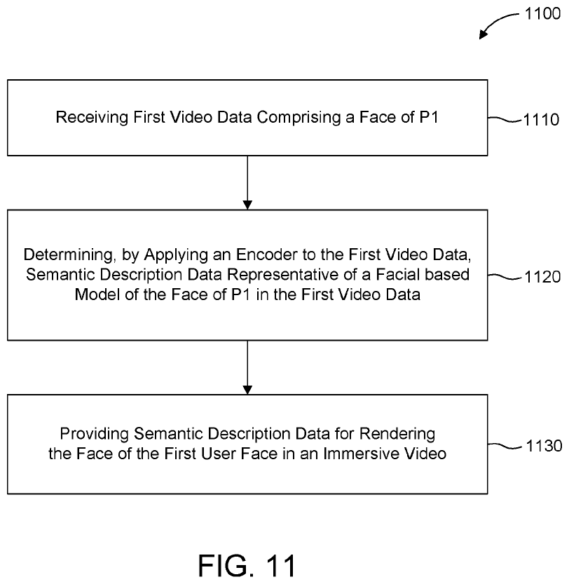

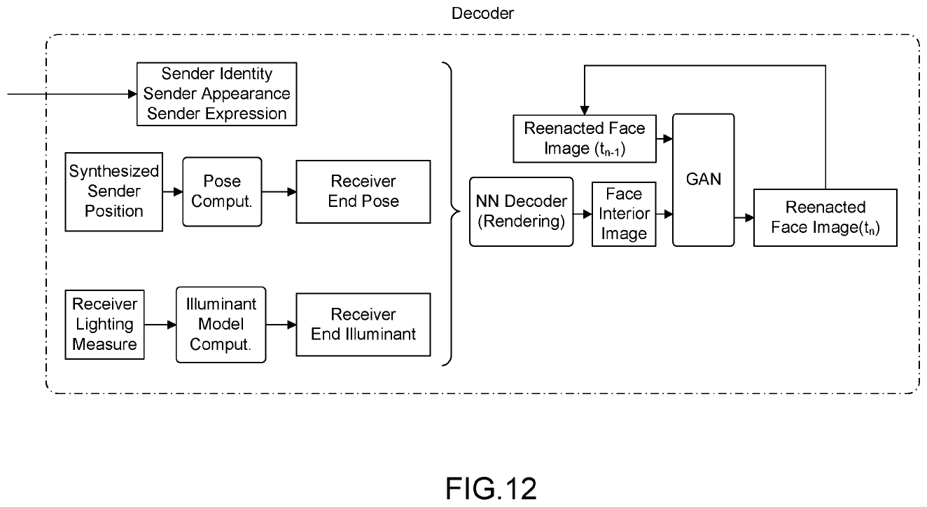

FIG. 11 illustrates a method 1100 for encoding semantic description data representative of a face of a user according to an embodiment. In a first step 1110, video data is received, the video data comprising a face of a user. In an encoding step 1120, a task corresponding to the 3D model extraction module of FIG. 4 is applied to the video data to obtain semantic description data representative of the 3D geometric and photometric model of the face of the user in the first video data. As mentioned above, the model addresses only the interior part of the face, including the eyes, nose and mouth but not the hair. According to a variant, the semantic description data at the output of the encoding step 1120 comprises:
an indication of an identity representative of a physiognomy of the user with a neutral expression, for instance a 3D mesh representing the 3D geometry of the sender's face with a neutral expression;
an indication of an expression representative of an emotional expression with respect to the neutral expression of the user, for instance a plurality of displacements of vertices of the 3D mesh incurred by the facial expression; and
an indication of an appearance representative of a reflectance of the user, for instance a skin reflectance on the surface of the 3D mesh;
an indication of a rigid head pose representative of the 3D rotation and translation of the face in the input video image with respect to the fronto-parallel viewpoint;
and indication of an illuminant such as a parametric model of the lighting environment of the face.

In principle, these components are extracted because the full face model is needed for the autoencoder according to the variant of FIG. 6 to work, but they all do not need be transmitted as some of them are replaced by components of the immersive video. Advantageously, even more bitrate is saved.

Thus, in a step 1130, the extracted semantic description data is provided to a remote decoder for rendering of the face in the input video into an immersive video. Advantageously, only a part of the above-mentioned components of the semantic description data are provided to the remote decoder, namely the identity, the expression and the appearance components. The semantic description data is completed at the decoding side by a rigid head pose of the face of the user in the immersive video and an illuminant as a parametric model of a lighting of an environment of the immersive video.

In the methods for encoding/decoding at least one image described above, results are provided for face images, however, the present principles are not limited to this kind of images and the methods provided herein applies to any other kind of images, as long as a model is available.

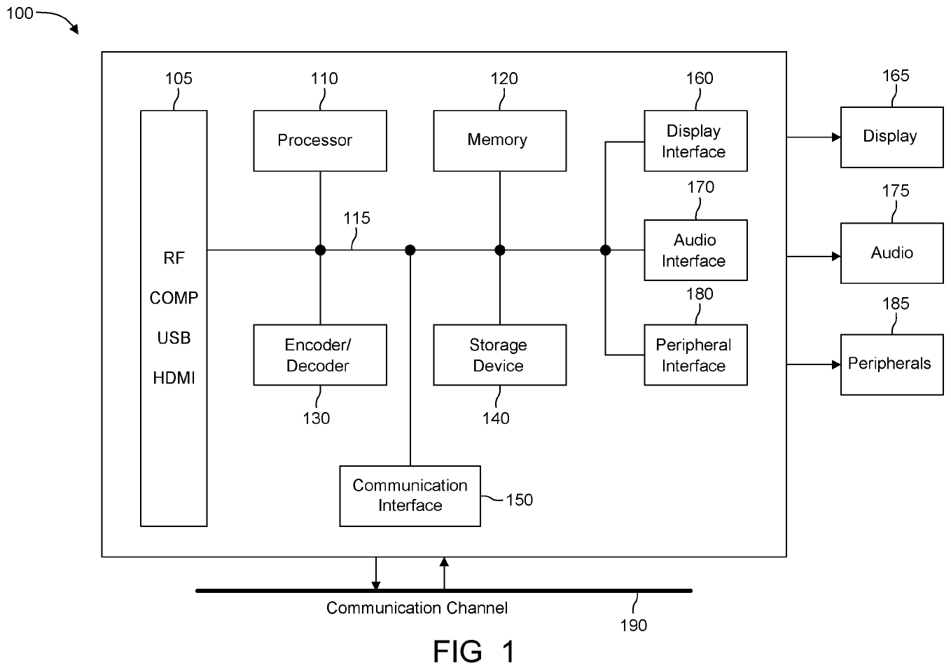

FIG. 1 illustrates a block diagram of a system within which aspects of the present embodiments may be implemented, according to an embodiment. FIG. 1 shows schematically a communication apparatus, for instance the videoconference device of FIG. 3 according to an embodiment.

According to an embodiment, the methods described above are implemented as instructions causing one or more processors to perform the methods steps.

According to an embodiment, FIG. 1 illustrates a block diagram of an example of a system in which various aspects and embodiments described above can be implemented. System 100 may be embodied as a device including the various components described below and is configured to perform one or more of the aspects described in this application. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

According to an embodiment, system 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, one of more input video shots, mosaic images, warpings, 3D models, color transform information, visibility maps, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during pre-processing steps of the method described herein and/or video editing. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the data-stream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

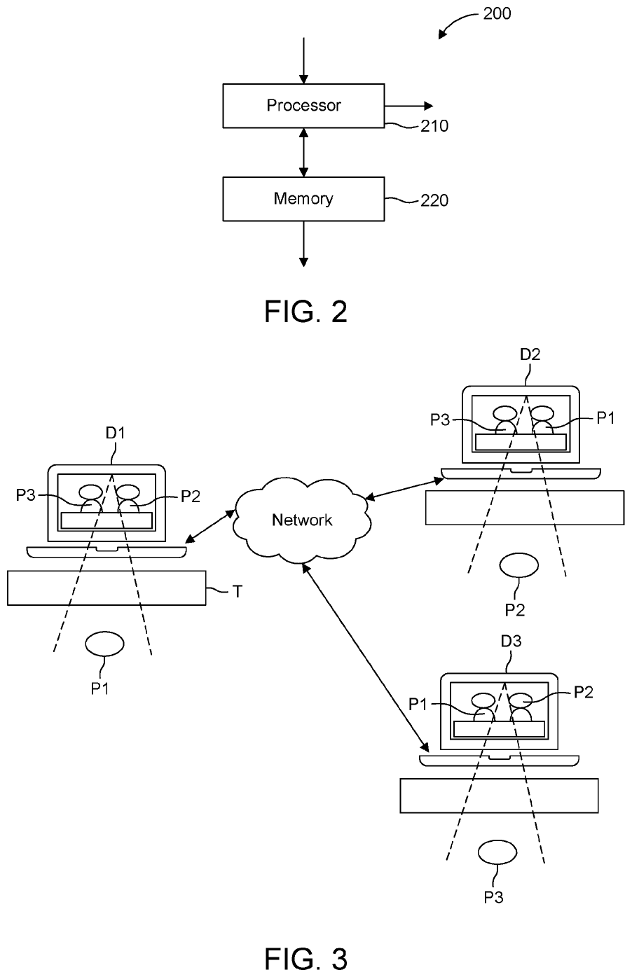

FIG. 2 illustrates a block diagram of a system within which aspects of the present embodiments may be implemented, according to another embodiment. FIG. 2 shows schematically a communication apparatus, for instance the communication device of FIG. 3 according to an embodiment. FIG. 2 shows one embodiment of an apparatus using the aforementioned methods. The apparatus comprises Processor 210 and can be interconnected to a memory 220 through at least one port. Both Processor 210 and memory 220 can also have one or more additional interconnections to external connections.

Processor 210 is also configured to either receive an image or output a generated image and encode at least one image or decode at least one image, using the aforementioned methods.

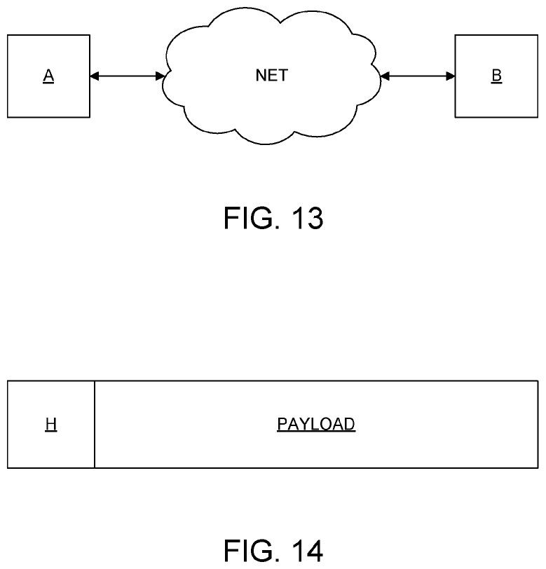

According to an example of the present principles, illustrated in FIG. 13, in a transmission context between two remote devices A and B over a communication network NET, the device A comprises a processor in relation with memory RAM and ROM which are configured to implement any one of the embodiments of the method for encoding at least one image as described in relation with the FIG. 5, 7 or 11 and the device B comprises a processor in relation with memory RAM and ROM which are configured to implement any one of the embodiments of the method for decoding at least one image as described in relation with FIG. 5, 7, 8, 9, 10 or 12.

In accordance with an example, the network is a broadcast network, adapted to broadcast/transmit encoded images from device A to decoding devices including the device B.

A signal, intended to be transmitted by the device A, carries at least one bitstream comprising coded data representative of at least one image.

FIG. 14 shows an example of the syntax of such a signal when the at least one coded image is transmitted over a packet-based transmission protocol. Each transmitted packet P comprises a header H and a payload PAYLOAD.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Unless indicated otherwise, or technically precluded, the aspects described in this application can be used individually or in combination.

Various numeric values are used in the present application. The specific values are for example purposes and the aspects described are not limited to these specific values.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method comprising:
receiving semantic description data representative of a three-dimensional (3D) model of a face of a user;
determining a head pose of the face of the user in an immersive video;
determining a parametric model of a lighting of an environment of the immersive video;
synthesizing the face of the user using the semantic description data with the head pose and under the parametric model of the lighting of the environment of the immersive video; and
generating a modified immersive video comprising an image of the synthesized face of the user in the immersive video.

2. The method of claim 1, wherein semantic description data representative of a 3D model of a face of a user comprises:
an indication of an identity representative of a physiognomy of the user with a neutral expression;
an indication of an expression representative of an emotional expression or a deformation of the face incurred by uttering speech with respect to the neutral expression of the user; and
an indication of an appearance representative of a reflectance of the face of the user.

3. The method of claim 2 wherein the indication of an identity is a 3D mesh representing a 3D geometry of the face with a neutral expression.

4. The method of claim 3 wherein the indication of expression comprises a plurality of displacements of vertices of the 3D mesh incurred by the emotional expression.

5. The method of claim 3 wherein an indication of appearance comprises a reflectance on a surface of the 3D mesh.

6. The method of claim 1 wherein the head pose of the face of the user in an immersive video comprises an indication of 3D rotation and translation of the face in an image of the immersive video with respect to a fronto-parallel viewpoint.

7. The method of claim 1 wherein the generating of the modified immersive video further comprises:
generating an image of the synthesized face of the user against a uniform background; and
compositing the generated image of the synthesized face of the user extracted from the uniform background into the immersive video.

8. The method of claim 1 wherein the generating takes at input the synthesized face of the user and the modified immersive video at a previous frame.

9. The method of claim 8 wherein the generating of the modified immersive video uses a generative adversarial network.

10-14. (canceled)

15. An apparatus, comprising one or more processors configured to:
receive semantic description data representative of a three-dimensional (3D) face-model of a face of a user;
determine a head pose of the face of the user in an immersive video;
determine a parametric model of a lighting of an environment of the immersive video;
synthesize the face of the user using the semantic description data with the head pose and under the parametric model of the lighting of the environment of the immersive video; and
generate a modified immersive video comprising an image of the synthesized face of the user in the immersive video.

16. The apparatus of claim 15 wherein semantic description data representative of a 3D model of a face of a user comprises:
an indication of an identity representative of a physiognomy of the user with a neutral expression;
an indication of an expression representative of an emotional expression or a deformation of the face incurred by uttering speech with respect to the neutral expression of the user; and
an indication of an appearance representative of a reflectance of the face of the user.

17. The apparatus of claim 16 wherein the indication of an identity is a 3D mesh representing a 3D geometry of the face with a neutral expression.

18. The apparatus of claim 17 wherein the indication of expression comprises a plurality of displacements of vertices of the 3D mesh incurred by the emotional expression.

19. The apparatus of claim 17 wherein an indication of appearance comprises a reflectance on a surface of the 3D mesh.

20. The apparatus of claim 15 wherein the head pose of the face of the user in an immersive video comprises an indication of 3D rotation and translation of the face in an image of the immersive video with respect to a fronto-parallel viewpoint.

21. The apparatus of claim 15 wherein to generate the modified immersive video, one or more processors are further configured to:
generate an image of the synthesized face of the user against a uniform background; and
composite the generated image of the synthesized face of the user extracted from the uniform background into the immersive video.

22. The apparatus of claim 15 wherein to generate the modified immersive video, one or more processors takes at input the synthesized face of the user and the modified immersive video at a previous frame.

23. The apparatus of claim 22 further comprising a generative adversarial network to generate the modified immersive video.

24-33. (canceled)
